(19) United States
(12) Patent Application Publication
(10) Pub. No.: US 2003/0014409 A1
(43) Pub. Date: Jan. 16, 2003

(54) Method and system for managing projects utilizing histogrammatical representations of real-time tasking and statusing

(76) Inventor: Shabina Shukoor, Jersey City, NJ (US)

Correspondence Address: Mitchell A. Stein, Esq., STEIN LAW, P.C., 24 Woodbine Avenue, Suite 4, Northport, NY, 11768, US

(21) Appl. No.: 10/194,031

(22) Filed: Jul. 11, 2002

Related U.S. Application Data
(60) Provisional application No. 60/304,679, filed on Jul. 11, 2001.

(51) Int. Cl. G06F 7/00

(52) U.S. Cl. 707/7

(57) ABSTRACT

A method and system for managing a project is shown, having the steps of dividing the project into at least one category; dividing each such category into at least one subtask; creating a hierarchical data model inverted such that the at least one subtask is above the at least one category; designating at least two statuses for the at least one subtask; determining a status for the at least one subtask; placing the designations for the at least two statuses along an axis and defining a columnar axis for each such at least two statuses, ordinal to the axis; stacking the at least one subtask along the columnar, ordinal axis conforming with one of the at least two statuses in accordance with the determination; and creating a histogrammatical representation of the stacked at least one subtask, along with the at least one category. Further steps include tracking the performance of the at least one subtask over time; redetermining a status for the tracked, at least one subtask; re-stacking the tracked, at least one subtask in accordance with the redetermination; and creating an additional histogrammatical representation of the re-stacked, tracked, at least one subtask, along with the at least one category. Additional steps include comparing the histogrammatical representation and the additional histogrammatical representation, and managing the project in accordance with the comparison. The statuses are generally selected from the group consisting of “not started,” “started,” and “done,” although other statuses are employed when appropriate. The system further includes designations for categories, supertasks, tasks and subtasks, linkages, historical logs and interdependencies.

### CONTINUING DATA

The instant application corresponds to provisional Patent Application Serial No. 60/304,679, filed Jul. 11, 2001, and, in accordance with 35 U.S.C. §119(e), benefit from the earlier filing date is claimed. The entirety of the aforementioned provisional Patent Application is hereby incorporated herein, by reference.

### FIELD OF THE INVENTION

The present invention relates to the field of workflow management, specifically to management of projects that can be divided into a plurality of tasks having statuses that can be tracked, and more specifically to a method and system for histogrammatical representations of projects divided into tasks having statuses.

### BACKGROUND OF THE INVENTION

In this 21^{st} century, as projects increase in complexity, it becomes necessary to determine systems and methods for managing the associated workflow. In particular, projects can be divided into a plurality of different tasks, each of which have a causal connection to the entire project, and each of which hase a status that ranges from unstarted to completed. Adding to the complexity of the situation lies the need to manage people and other resources and to determine where there are weaknesses and overtaxed resources. Accordingly, it is critically important to manage projects and resources and to optimize the equation to increase performance.

Traditional schemata for preparing and analyzing workflow utilize the familiar “tree” diagram wherein regional locations are broken into departments, projects, phases and tasks, in downward progression, as shown more specifically in FIG. 1. In this example of the prior art, a fictional company is divided into three region categories 2, in this instance northeast region projects, midwest region projects, and western region projects. Below the region categories 2 are the first level “branches” of the tree, which in the FIG. 1 example comprises departments 4, in this instance a sales and technology department for each region category 2. Below the departments 4 comprise project categories 6, in this instance projects M, ABC, X, Y Z and Q. On the next level of FIG. 1, below the departments 4, are phase categories 8, which are three in number for each of the project categories 6. Tasks 10 are then shown below for each phase. Connecting lines indicate connectivity between the various levels of the tree.

This traditional organizational chart shown in FIG. 1 has a number of drawbacks. For starters, as is evident, there is a large amount of wasted space on the page. Additionally, while connectivity is shown, the status of the projects are not available, and while perhaps the most important aspect of management, would require a hyperlink of some kind in order to be rendered visible, thereby taking the task to another page, and, at that point, failing to maintain a consistent visual representation of connectivity to the remainder of the tasks, phases, projects, departments and regions. The user must return from the hyperlink, and this added step creates a confusing management tool to the end user. Indeed, one could well imagine a large organization being unable to even represent the entirety of the organization on one page if the tool shown in FIG. 1 is used, since the wasted space is unavailable.

FIG. 2 shows a typical configuration of an enterprise project control system, known by those of ordinary skill in the art, with a graphical process map shown in screen capture 12, revealing a typical user interface, wherein the graphical elements represent tasks within an overall process. Like its predecessor in FIG. 1, however, statuses for the tasks are not immediately evident, and a considerable amount of space on the page is wasted as a result of the graphical technique utilized for representation purposes. Screen capture 14, as shown in FIG. 2 is a series of pull down menus and forms that are asked by hyperlinking from the graphical elements shown in screen capture 12. In reality, while the screens are shown next to each other in FIG. 2, the user has left capture 12 when viewing capture 14, and hence must return in order to determine the visual relationship.

FIG. 3 represents a multilayer approach 15 to modeling an enterprise, in this instance broken into four systems: a business organization editor 16, business function editor 18, business process editor 20 and desktop generator and parameter setter 22. Each of the editors 16, 18 and 20 permit creation of a business organization model, function model and process model, respectively, representing the entire enterprise which are, in turn brought together with appropriate background functions via desktop generator and parameter setter 22.

The FIG. 3 prior art modeling device is dysfunctional, because the separation of organizational, functional and process models creates a fragmented view of the enterprise, hence making it very difficult to be effectively learned, understood, implemented, navigated, and maintained.

It is thus an object of the instant invention to provide a system and method for visually presenting an organization by way of categories, supertasks, tasks and subtasks (defined to include all relevant organizational structural elements) without wasted space on the page, and with status information indicated for the subtasks in a simple, easily navigable, and reverse hierarchical manner.

It is another object of the instant invention to enable a single layer visual representation of an entire organization and the status of its functions, with other organizationally significant functions rendered available, including data manipulation, forecasting, modification of business processes, reporting, budgeting, and the like.

It is still another object of the instant invention to provide a “bottom up” histogrammatical modeling system (in comparison to a top down system), with subtasks representing the top visual level, and broad categories representing the lower visual levels.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through a method and system for managing a project is shown, having the steps of dividing the project into at least one category; dividing each such category into at least one subtask; creating a hierarchical data model inverted such that the at least one subtask is above the at least one category; designating at least two statuses for the at least one subtask; determining a status for the at least one subtask; placing the designations for the at least two statuses along an axis and defining a columnar axis for each such at least two statuses, ordinal to the axis; stacking the at least one subtask along the columnar, ordinal axis conforming with one of the at least two statuses in accordance with the determination; and creating a histogrammatical representation of the stacked at least one subtask, along with the at least one category. Further steps include tracking the performance of the at least one subtask over time; redetermining a status for the tracked, at least one subtask; re-stacking the tracked, at least one subtask in accordance with the redetermination; and creating an additional histogrammatical representation of the re-stacked, tracked, at least one subtask, along with the at least one category. Additional steps include comparing the histogrammatical representation and the additional histogrammatical representation, and managing the project in accordance with the comparison. The statuses are generally selected from the group consisting of “not started,” “started,” and “done,” although other statuses are employed when appropriate. The system further includes designations for categories, supertasks, tasks and subtasks, linkages, historical logs and interdependencies.

Features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 is a “top down” work breakdown structure in accordance with the prior art;

FIG. 2 is a series of screen captures of other prior art process modeling systems;

FIG. 3 is a diagrammatical representation of a prior art enterprise modeling system;

FIG. 4 is an overall system design of the method and system of the instant invention;

FIG. 5 is a visual representation of a rearrangement of the FIG. 1 prior art structure to demonstrate “bottom up” styled redesign, in accordance with a phase of the instant invention;

FIG. 6 is a visual representation of a second phase of the instant invention showing spacial compression and contained stacking and ordering in accordance with the subject invention;

FIG. 7 is a visual representation of a third phase of the instant invention showing demarcations between regions, departments, projects, and phases, in accordance with the instant invention;

FIG. 8 is a bird's-eye view of an example of a live project mapped in accordance with a preferred embodiment of the subject invention;

FIG. 9 is a two-dimensional view of an actual versus expected curve comparisons of live project behavior, modeled in accordance with another embodiment of the subject invention;

FIG. 10 is a process flow chart of a preferred embodiment of the subject invention;

FIG. 11 (A through J) show screen captures of the process shown in FIG. 10, in accordance with a preferred embodiment of the subject invention.

### DETAILED DESCRIPTION OF THE PREFERRED EMBODIMENTS

In accordance with the subject invention, FIG. 's 1 and 3 represents view of the prior art modeling systems, as discussed in greater detail above. In distinction from these systems, and of key critical import to the subject invention lies the inversion and compression stages of the subject invention, and a series of other steps in the method and system which provide greater visual clarity and enterprise planning ability.

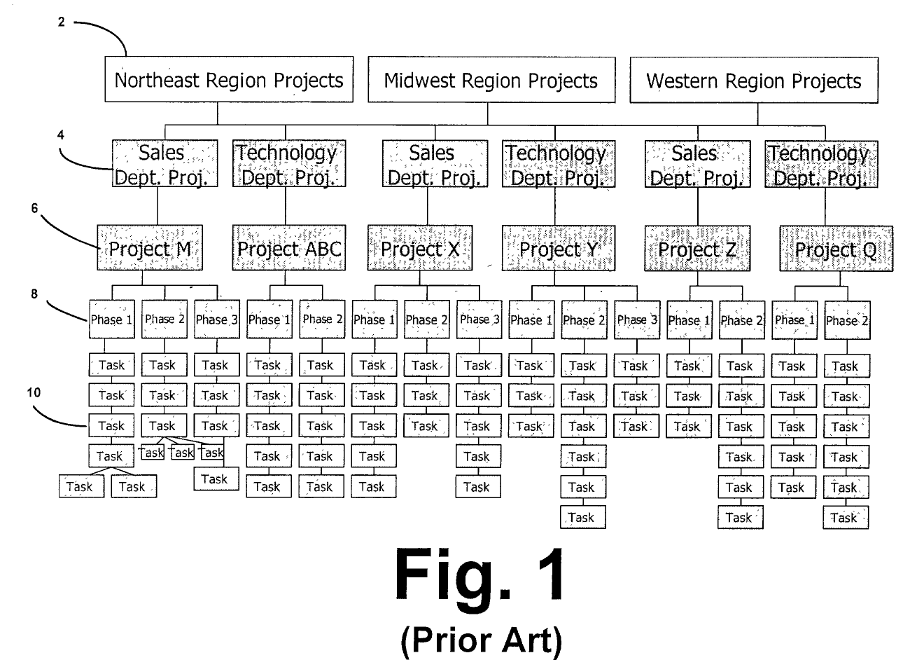

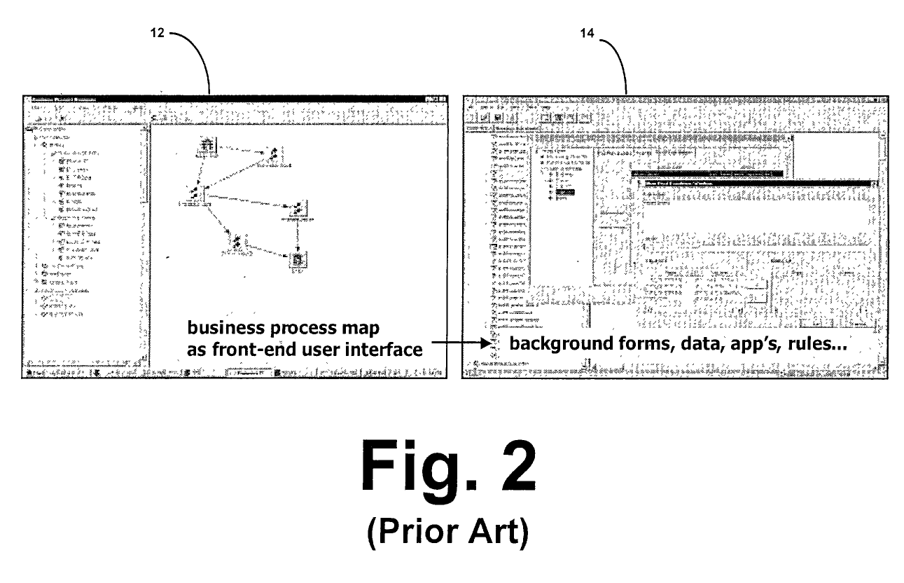

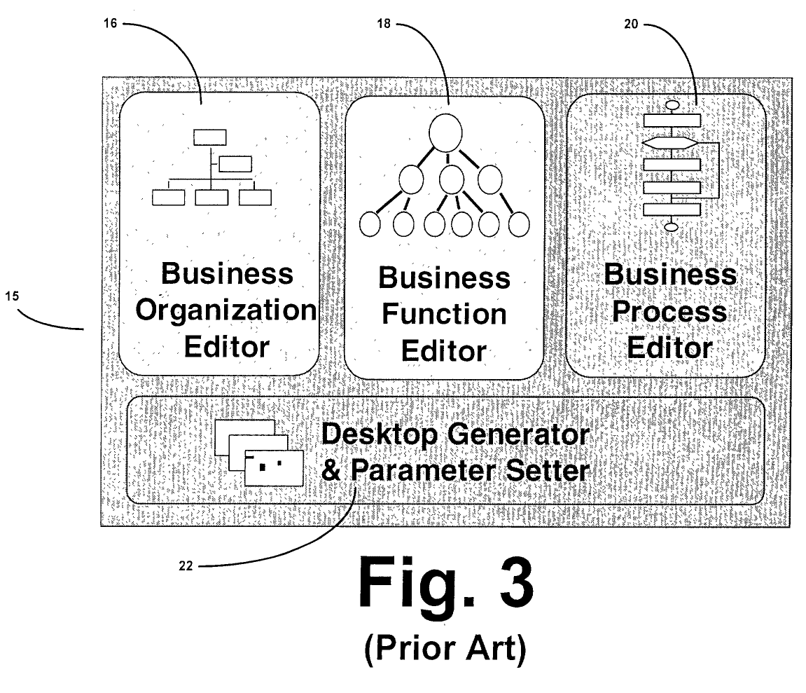

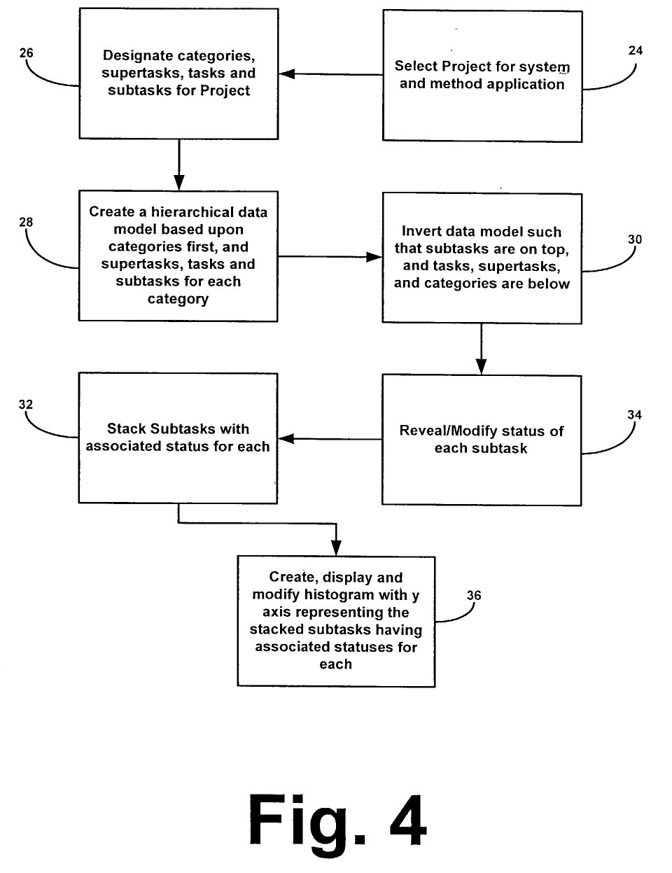

FIG. 4 shows an overall system diagram of an embodiment of the subject invention, in which a project is first selected for application of the system and method via step 24, and next categories, supertasks, tasks and subtasks for the project are designated in step 26. It should be appreciated that categories, supertasks, tasks and subtasks are systematically connected, such that a category is designated and is comprised of supertasks which can, and are themselves broken into tasks, which are in turn broken into subtasks. By way of example, if the category designations are departments (see, e.g., departments 4 in prior art example shown in FIG. 1, or stated another way, if there are also subcategories and the categories are regions 2 and subcategories are departments 4), then under each category are supertasks (e.g., projects 6 in FIG. 1), tasks (e.g., phases 8 in FIG. 1), and subtasks (tasks 10 in FIG. 1) are designated in step 26 of FIG. 4. Thereafter, a hierarchical data model is created via step 28 based upon the categories, first, and supertasks, tasks and subtasks next for each category.

In critical distinction from all of the prior art methods and systems, once the hierarchical data model model is created via step 28, it is inverted via step 30 such that the subtasks are shown on top, and the tasks, supertasks and categories are represented below. The shapes containing each element are fitted such that shapes containing subtasks are seamlessly fitted such that they may be stacked geometrically to fit within the width boundaries of the higher level tasks at the step below. In this stacking mechanism, all of the white space can thereafter be eliminated as a result of the special geometries invoked (and as shown and described in greater detail in the subsequent FIG. 's 6 and 7) and the image compressed, as further discussed below. Thereafter, the status of each subtask can be revealed and modified via step 34, such that real time changes can be indicated, as the project evolves. The subtasks are thereafter rearranged via step 32 such that they may be inserted in a status category for each, in at least one embodiment, described below, in which the status is either “not started,” “started,” or “done.” Accordingly, all of the subtasks in a particular task, supertask and category are stacked in accordance with the designated status, and, utilizing the method and system, can be rearranged to a different status to reflect real-time change in actual status. Thus, via step 36, the method and system permits the creation, display and modification of a histogram with the “y” axis representing the stacked subtasks having associated status (as shown in the “x” axis) for each.

One of ordinary skill in the art will well appreciate that by stacking the subtasks in accordance with their respective statuses in the manner indicated herein, a visual pattern is shown which, while involving blocks can also achieve a visual curve presentation which represents a “snap shot” of the then actual statuses of each of the subtasks, arranged in accordance with tasks, supertasks and categories. Thus, after rearrangement in accordance with a later point in time, one can compare performance from the earlier histogrammatical visual presentation to the latter and compare either bar-type graphs (of block movements) or actual curves representing performance. Also, one can predict a future movement based upon anticipated dates of transition between statuses over time.

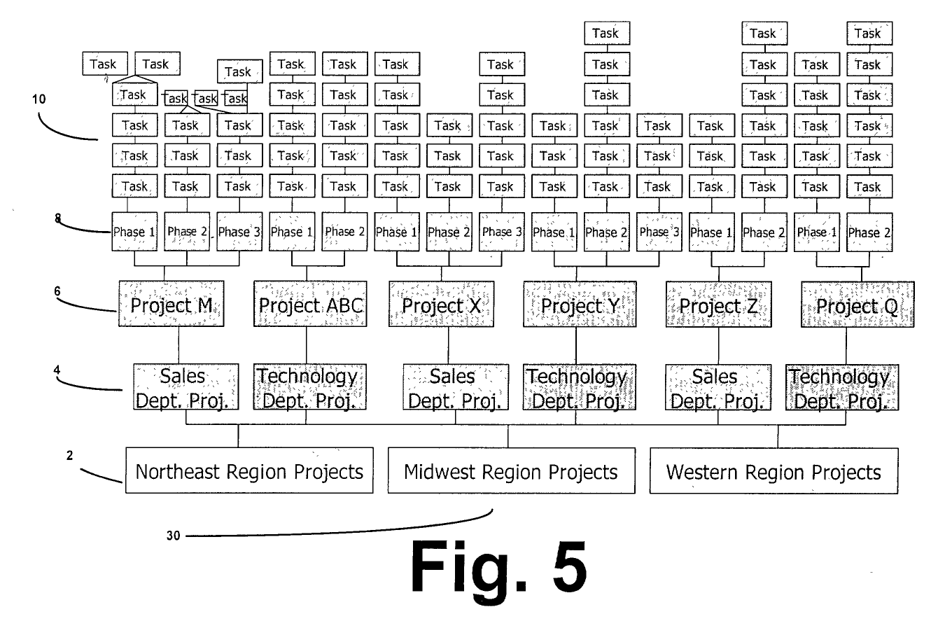

For the purpose of explanation only, FIG. 5 shows a portion of the system and method in distinction from that of the prior art. It can be appreciated that FIG. 5 is an inversion of FIG. 1 (in accordance with step 30 as shown in FIG. 4), with like elements bearing like numbers. In this manner a “bottom up” display with tasks at the top is shown.

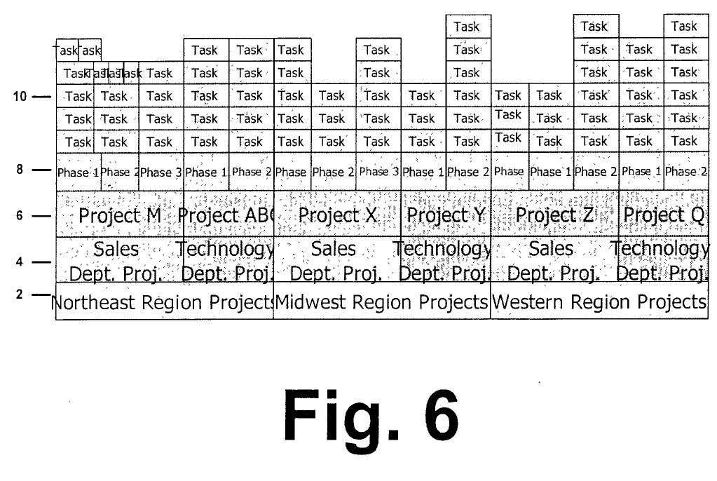

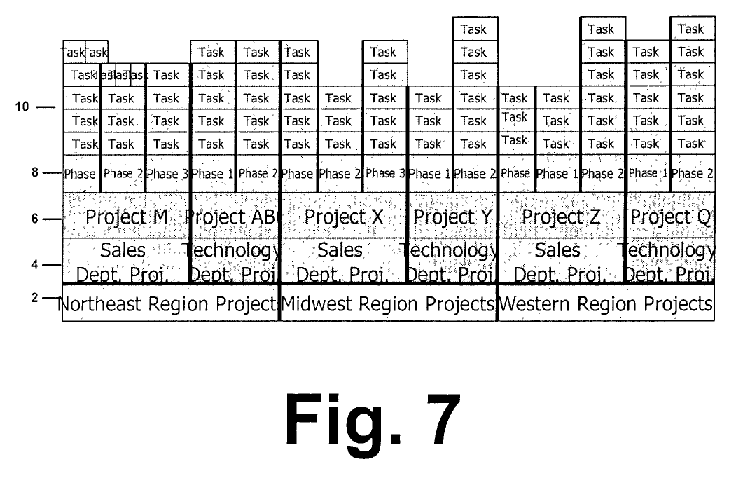

Now that the inversion (step 30 in FIG. 4) has occurred, as shown in FIG. 5, from the original prior art view (as shown in FIG. 1), it should be appreciated that substantially all of the blank white space can be eliminated, and the image compressed, as shown in FIG. 6. Thereafter, demarcations that conform with categories, supertasks and tasks can be created, as shown in FIG. 7, and one of ordinary skill in the art can now realize the visual presentation and simplification shown by the inversion and compression steps in accordance with the subject invention.

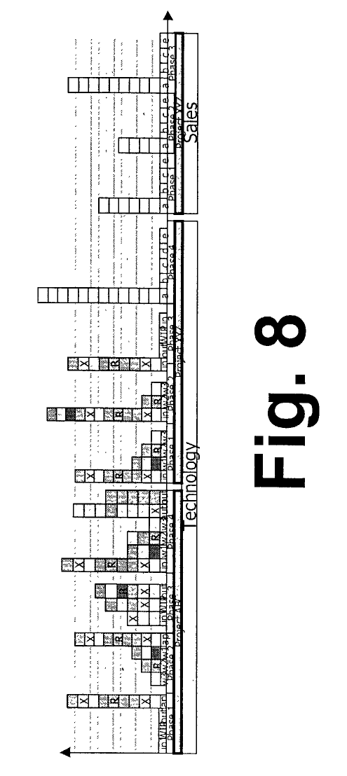

The improvement of the subject invention is further demonstrated by the view shown in FIG. 8, because beyond the rearrangement (inversion and compression) of the subject invention, the individual subtasks can also be oriented in accordance with each respective status—a visual presentation ability heretofore unknown to the art. FIG. 8 reveals a number of subtasks stacked in accordance with the subject invention in one of a plurality of statuses, and a visual curve (block or otherwise) is revealed which represents a histogram or “snap shot” of that point in the project's life cycle. In this instance, the categories are broken into technology and sales for descriptive purposes only, and not to be construed as limiting the types, nature and number of such categories.

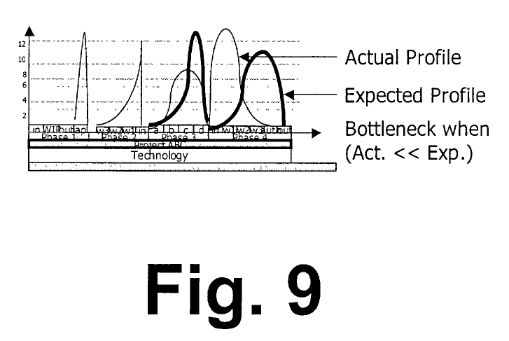

Thus, FIG. 9 represents a curve-based view of another aspect of the subject invention, in which an actual profile is overlayed upon an expected profile, in order that a bottleneck can be identified in real time, and hence a project manager can focus on the subtasks that are bottlenecked, for determination of responsibility from the original category, and can discuss and improve performance with those who's actual performance lagged behind the expected performance. It should be appreciated that the expected profile was determined based upon the project planning by designating dates and/or times in which the status of an individual subtask was expected to have changed from its original “not started” point to some other point. At a future date of tracking, when one or more subtasks in reality switched statuses, the dates recorded at the actual time of switching represents the actual profile, such that the comparison could be made, as shown in FIG. 9.

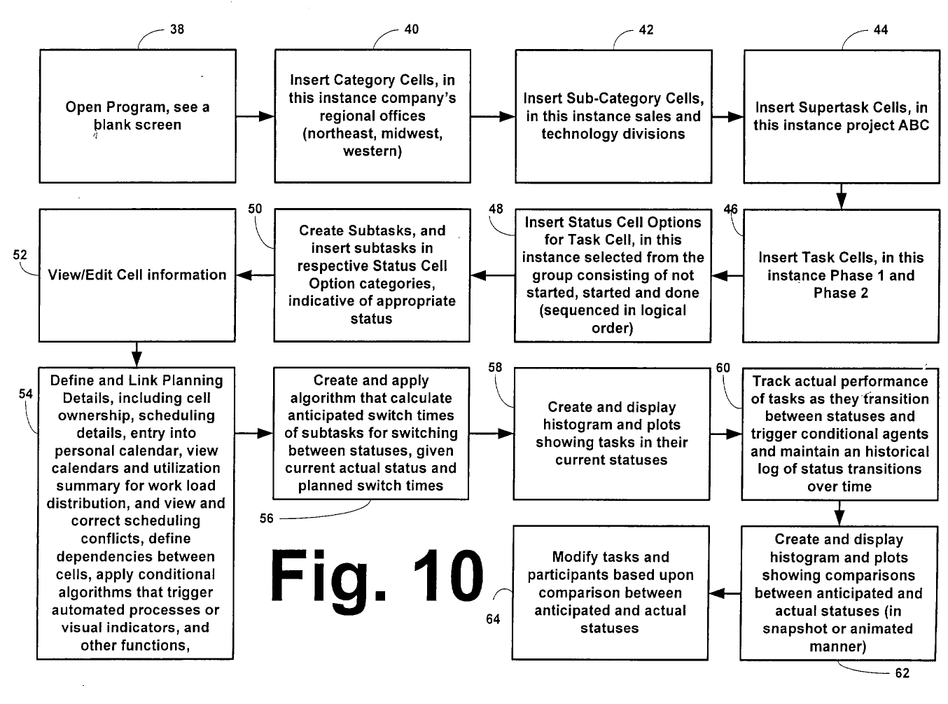

FIG. 10 shows a flow chart of the system in accordance with a preferred embodiment of the subject invention. In step 38, the program or device (preferentially a computer-based program) is opened and a blank screen is seen. The user of the device, via step 40, then inserts category cells, in this instance a company's regional offices (northeast, midwest and western) to conform with the example shown in FIG. 5. It should be appreciated that the example is for example purposes only, and should not be construed as limiting the subject invention to the specific categories shown. To conform with this example, sub-category cells (in this instance sales and technology divisions) are inserted next via step 42. Supertask cells (in this instance project ABC) are inserted via step 44. Task cells (in this instance phase 1 and phase 2) are inserted via step 46. Status cell options are then created via step 48 (such that subtasks can be inserted into the requisite status column, via step 50). In this instance, three status cell options are selected (not started, started and done), although a greater, lesser or a different group of such options can be selected without deviating from the letter, spirit or scope of the subject invention. These three statuses are most convenient in operation, since they reflect actual statuses for most, if not all, of task functions that start and end over a period of time.

Once the status cell option columns have been created by step 48, the subtasks can be created via step 50 and placed within the respective status cell option categories, indicative of the appropriate status. Thus, for example, subtasks that have not been started are stacked in the column of “not started,” those that have been started in the column “started” and those completed in the column “done.” It should be well appreciated at this point, that histograms taken at different actual points of time will reflect actual statuses which have varied from commencement until that point in time, and hence each histogram can be compared with other histograms to show trends and tracking, in a profound manner, in comparison to that heretofore known in the art. Step 52 permits viewing and editing of cell information which enables modifications and corrections, as well as movement to various status categories.

Step 54 permits the definition and linking for planning details, including cell ownership (management, teams and actionees), scheduling details (in this instance start dates and end dates), cross-referencing for entry into personal calendars (such that an individual's calendar is updated, conflicts checked and resolved, and the individual can then and thereafter know the schedule), utilization summaries can be shown (linked and/or verified) for workload distribution, dependencies between cells can be created (that is, “if-then” type situations where one subtask depends from the start and/or completion of another), conditional algorithms can be created for automatic processing (like email and/or voice mail alerts) and visual indication (like flags and the like), and other functions can be performed that those of ordinary skill in the art will easily comprehend by access to the subject invention and its description contained herein.

Step 56 powerfully enables the creation and application of algorithms to switch the status for subtasks based upon predetermined switch times, such that the method and system can permit the user to determine the histogram at another, future point in time, based upon the anticipated start and end times for the individual subtasks.

Step 58 enables the creation and display of histograms, which enables plotting showing subtasks in their current statuses in a histogram-styled view.

It should now be abundantly evident, that the method and system permits tracking of actual performance (via step 60) of subtasks, tasks, and supertasks, as the subtasks transition between statuses, also triggering conditional agents (email triggers, batch processing, and the like) and the maintenance of historical logs showing the status transitions over time (actual). Likewise, historical logs can be utilized to calculate anticipated statuses transitions over time.

Thus, comparisons between anticipated and actual statuses are histogrammatically created and displayed via step 62. Such display can be in snapshot form (see, e.g., FIG. 's 8 and 9) or animated such that the time-based sequence of change is shown. Thus, interdependent and correlated functions (causally related like “if-then” functions) across an enterprise (normally invisible by way of traditional tools) are now made easily viewable.

Lastly, subtasks, tasks and supertasks can be modified and the participants changed via step 64, based upon anticipated and actual statuses, as time progresses and the categorical projects are performed.

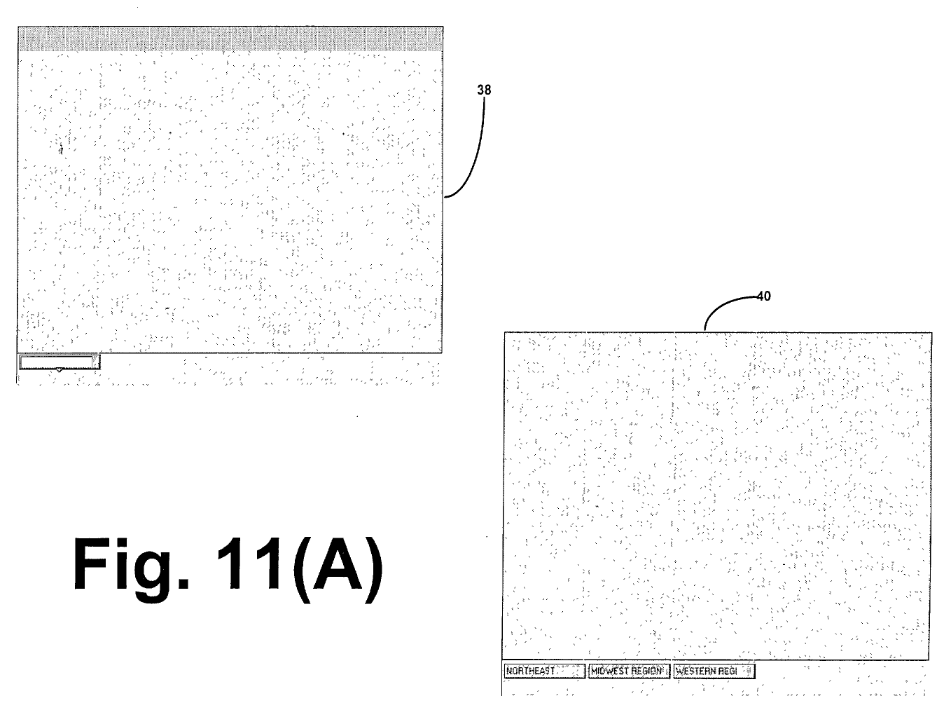

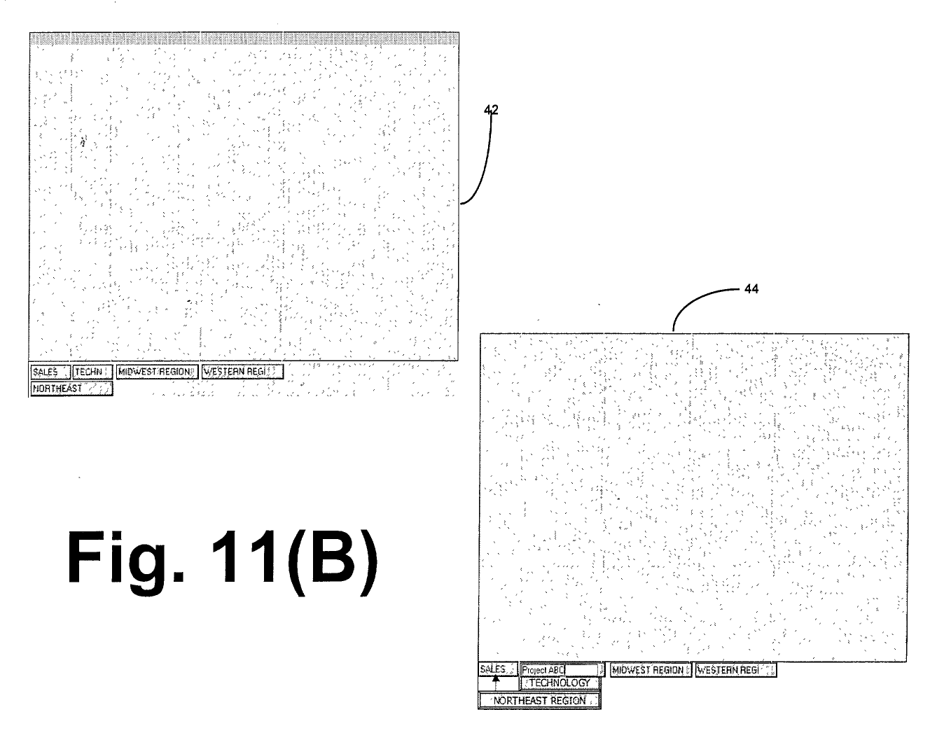

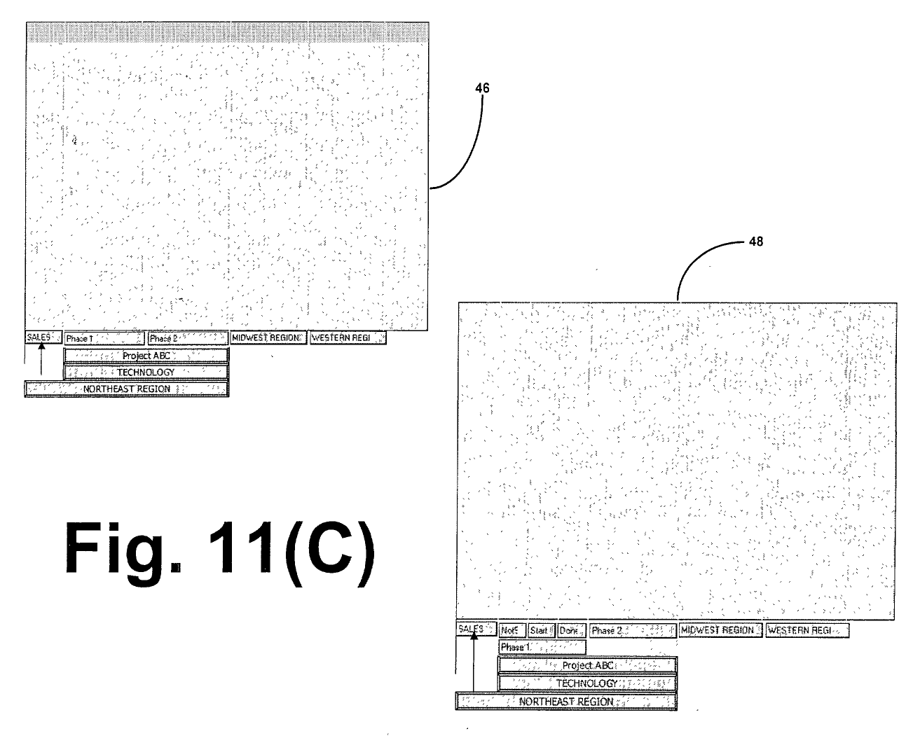

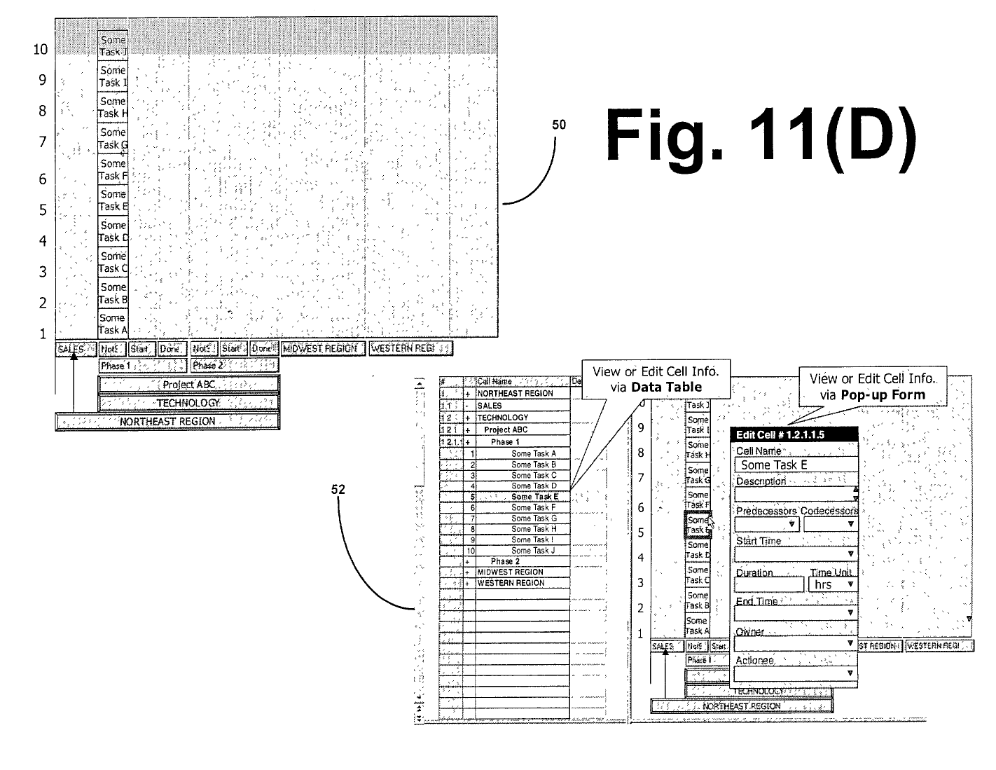

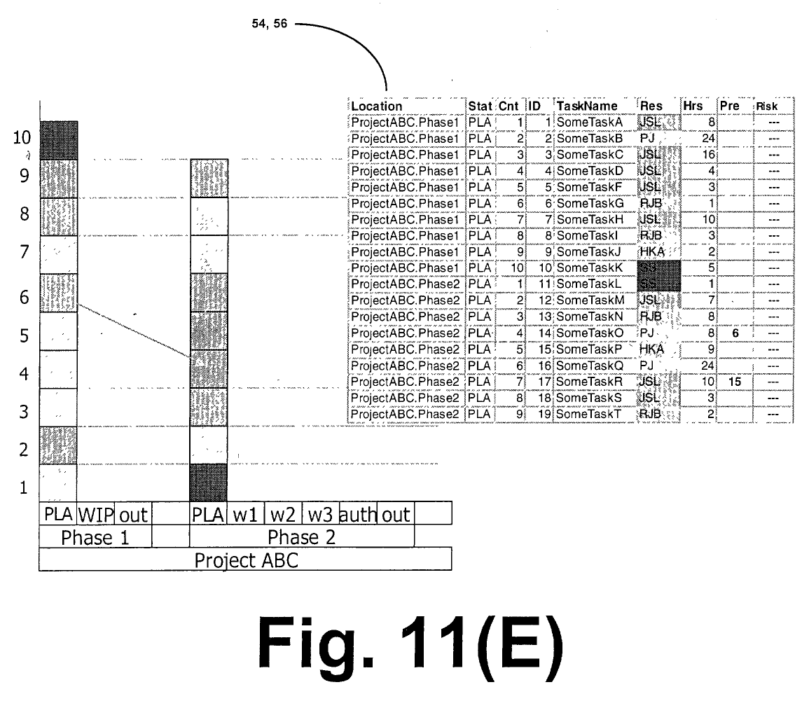

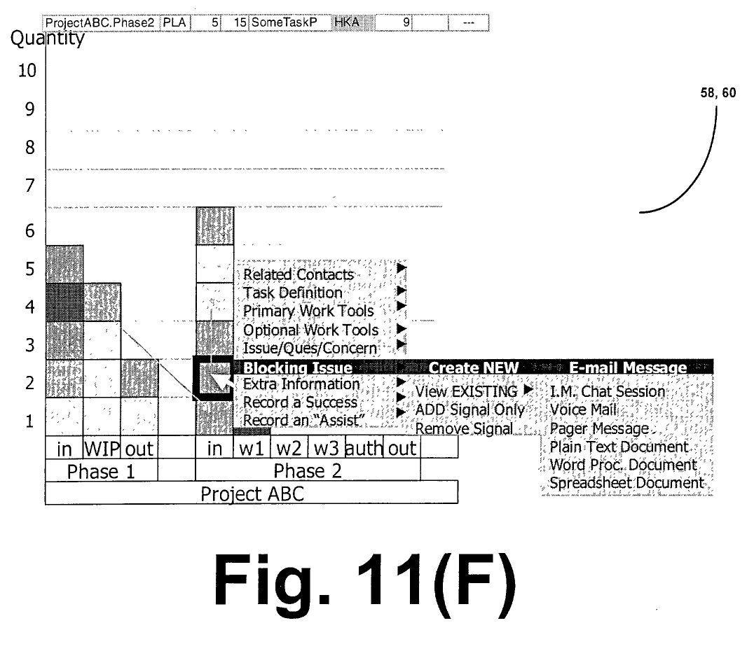

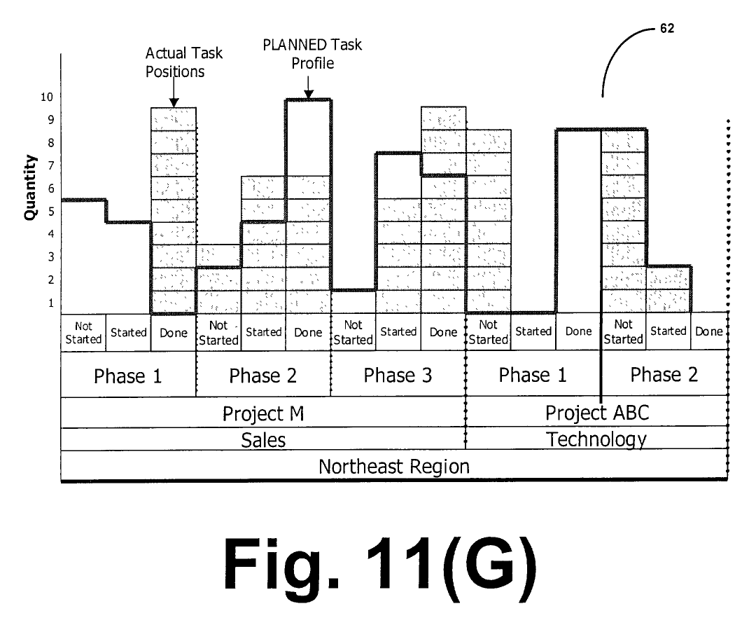

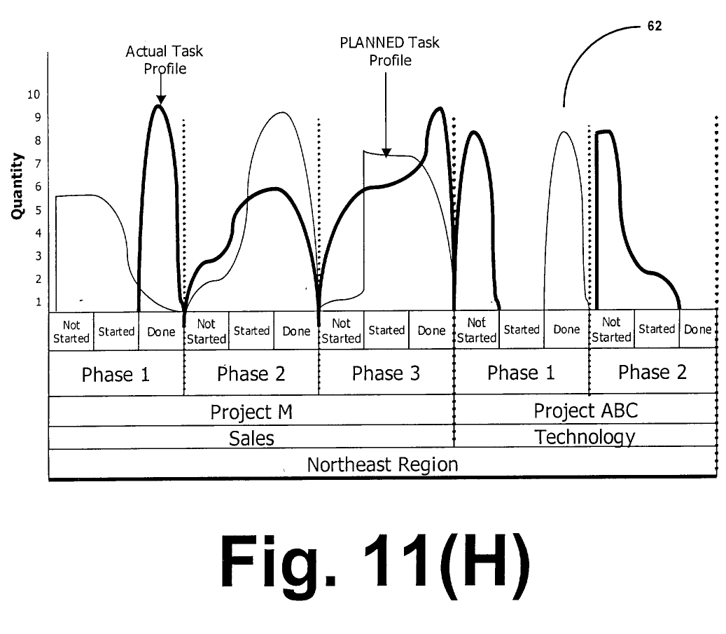

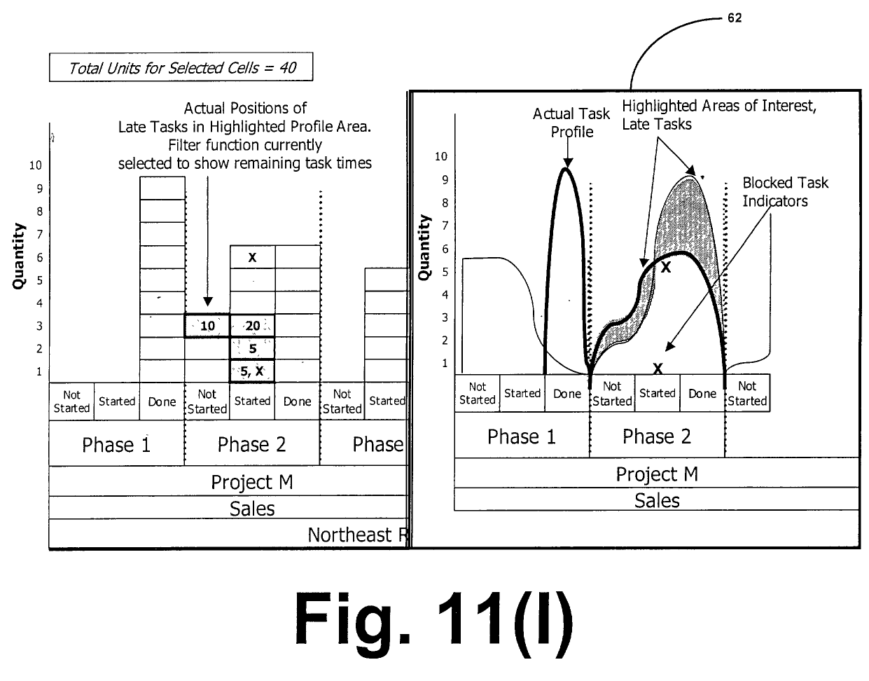

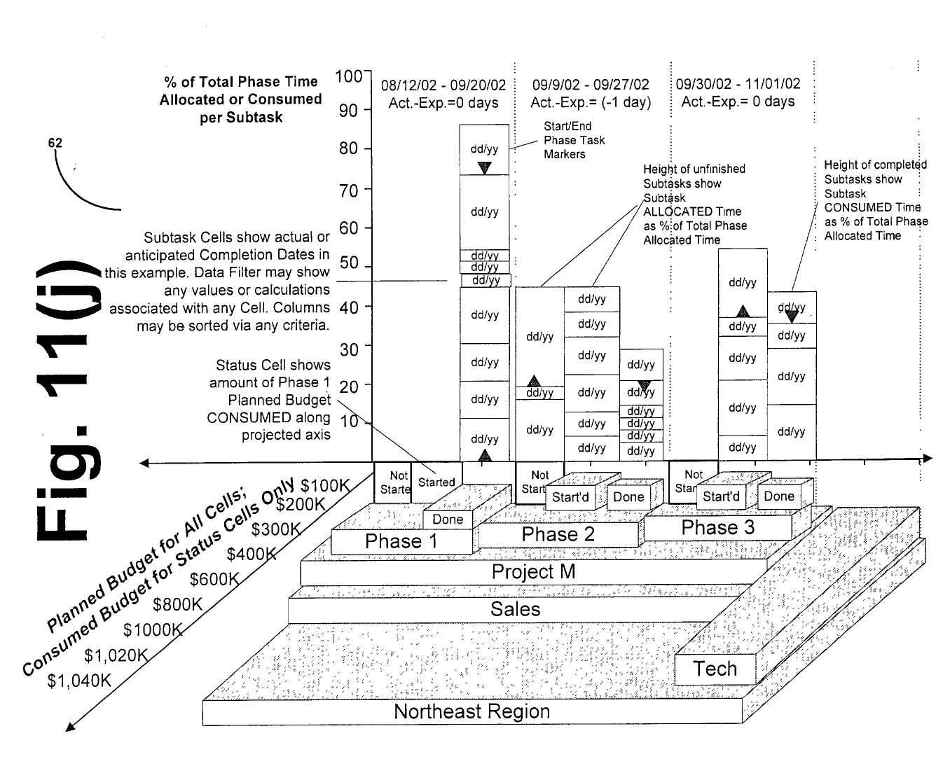

FIG. 11(A) through FIG. 11(m) show the individual screen captures of the method and system in implementation, connected to the steps shown in FIG. 10, in which the step numbers bear the same numbers as the screen captures shown. Thus, in FIG. 11(A), opening step 38 and category insertion step 40 are shown. In FIG. 11(B), insert sub-category step 42 and supertask cells 44 are shown. In FIG. 11(C), insert task cells 46 and insert status cell options 48 are shown. In FIG. 11(D), create subtasks step 50 and view and edit step 52 are shown. In FIG. 11(E), define and link step 54 and create and apply step 56 are shown. In FIG. 11(E), “PLA” means planning status, “WIP” means work in process, and “out” means “done.” It should be appreciated, as stated herein above, that the statuses can change to meet the specifics of the program. In FIG. 11(F), create and display step 58 and track step 60 are shown. In FIG. 11(G), an actual histogram is created (via step 62, see FIG. 10), which, in this representative embodiment, has a category of “northeast region,” sub-categories of “sales” and “technology,” supertasks of “project M” and “project ABC,” tasks of “phase 1,” “phase 2,” and “phase 3,” and individual tasks placed in statuses “not started,” “started,” and “done.” In the histogram shown in FIG. 11(G), actual task positions are shown against planned task profile (the step curve), and true project management is enabled.

Likewise, FIG. 11(H) shows another version of a histogram (created via step 62), in which, instead of a step curve, an actual curve is used to show the comparison between an actual task profile and a planned task profile, wherein the individual subtasks have been stacked, but curves generated.

FIG. 11(I), shows another histogram, created via step 62, in which the actual positions of late tasks (or any other area of interest) are highlighted by clicking by the manager in the profile area, and remaining tasks are thereby rendered visible. Thus, when comparing the actual task profile against the expected profile, the method and system permits identification of the specific tasks that are late and the remaining tasks, such that the project manager(s) can focus thereupon. Blocked task indicators show a problem based upon the original linking that occurred via step 54.

FIG. 11(j) shows a “z” dimension added, in accordance with another embodiment of the subject invention, which enables a comparison for costing purposes, wherein completed tasks are shown with respect to the amount of the budget consumed for such completion. The “y” axis in FIG. 11(j) also has changed the “y” height of the subtask cells to reflect the percentage of total phase time allocated or consumed, with start and end date indicators shown.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method for managing a project, comprising:
(a) dividing the project into at least one category;
(b) dividing each such category into at least one subtask;
(c) creating a hierarchical data model inverted such that said at least one subtask is above said at least one category;
(d) designating at least two statuses for said at least one subtask;
(e) determining a status for said at least one subtask;
(f) placing said designations for said at least two statuses along an axis and defining a columnar axis for each such at least two statuses, ordinal to said axis;
(g) stacking said at least one subtask along the columnar, ordinal axis conforming with one of said at least two statuses in accordance with said determination; and
(h) creating a histogrammatical representation of said stacked at least one subtask, along with said at least one category.

2. The method of claim 1, comprising the additional steps of:
(i) tracking the performance of said at least one subtask over time;
(j) re-determining a status for said tracked, at least one subtask;
(k) re-stacking said tracked, at least one subtask in accordance with said redetermination; and
(l) creating an additional histogrammatical representation of said re-stacked, tracked, at least one subtask, along with said at least one category.

3. The method of claim 2, comprising the additional step of:
(m) comparing said histogrammatical representation and said additional histogrammatical representation.

4. The method of claim 3, comprising the additional step of:
(n) managing the project in accordance with said comparison.

5. The method of claim 1, wherein said statuses comprise “not started” and “done.”

6. The method of claim 1, wherein said statuses comprise “started” and “done.”

7. The method of claim 1, wherein said statuses comprise “not started” and “started.”

8. A system for managing a project utilizing histogrammatical representation of real-time tasking and statusing, comprising:
(a) inserting category cells on a screen along an axis;
(b) inserting sub-category cells associated with each category cell immediately above the associated category cell, along a second axis;
(c) inserting supertask cells associated with each sub-category cell immediately above the associated category cell along said second axis;
(d) inserting task cells associated with each supertask cell immediately above the associated supertask cell;
(e) creating a plurality of status columns, such that the statuses are placed along said first axis, and the columns are defined along said second axis;
(f) creating a plurality of subtask cells associated with each task cell;
(g) designating a status for each subtask cell that conforms with one of said status columns;
(g) placing said subtask cells above each associated task cell in the column that conforms with said status designation; and
(h) creating and displaying a histogram showing the placed subtasks, tasks, supertasks and categories.

9. The system of claim 8, comprising the additional steps of:
(i) tracking the performance of said at least one subtask cell over time;
(j) re-determining a status for said tracked, at least one subtask cell;
(k) re-stacking said tracked, at least one subtask cell in accordance with said redetermination; and
(l) creating an additional histogram of said re-stacked, tracked, at least one subtask cell, along with said task, supertask and category cells.

10. The system of claim 9, comprising the additional step of:
(m) comparing said histogram and said additional histogram.

11. The system of claim 10, comprising the additional step of:
(n) managing the project in accordance with said comparison.

12. The system of claim 8, wherein said statuses comprise “not started” and “done.”

13. The system of claim 8, wherein said statuses comprise “started” and “done.”

14. The system of claim 8, wherein said statuses comprise “not started” and “started.”

15. The system of claim 8, wherein at least two of said cells are linked and interdependent.

16. The system of claim 10, wherein the tracking step is repeated, and multiple histograms are created.

17. The system of claim 16, wherein the multiple histograms are maintained as an historical log.

18. The system of claim 16, wherein said multiple histograms are arranged in sequence and presented in an animated mode in accordance with said sequence.

19. The system of claim 10, further comprising the step of creating a third axis representing budget, and tracking in accordance therewith.

20. The system of claim 10, wherein the columnar dimension of each stacked subtask varies in dependency upon the percentage of a resource consumption.
